(19) United States
(12) Patent Application Publication
(10) Pub. No.: US 2010/0123312 A1
(43) Pub. Date: May 20, 2010

(54) RETROFIT ARRANGEMENT FOR PULSE JET DUST COLLECTORS

(75) Inventors: Steven C. Scott, Overland Park, KS (US); Charles Thom Martin, Lake Wylie, SC (US)

Correspondence Address: PEARNE & GORDON LLP, 1801 EAST 9TH STREET, SUITE 1200, CLEVELAND, OH, 44114-3108, US

(73) Assignee: BHA Group, Inc., Kansas City, MO (US)

(21) Appl. No.: 12/274,620

(22) Filed: Nov. 20, 2008

(51) Int. Cl. F16L 15/08; B23P 6/00; F16L 21/00

(52) U.S. Cl. 285/386; 29/402.08; 285/390

(57) ABSTRACT

A method of replacing an existing threaded coupler on an existing tubular fixture secured to a baghouse is provided to couple a pulse jet device to a blowpipe of the baghouse via the existing tubular fixture. The method includes the steps of disconnecting the blowpipe from the existing tubular fixture by removing the threaded coupler therefrom. The method further includes the steps of providing a spacer sleeve arranged co-axially within the existing tubular fixture, and providing a transfer tube arranged co-axially within the spacer sleeve. The method further includes the steps of coupling the transfer tube to the spacer sleeve, coupling the spacer sleeve to the existing tubular fixture, arranging the blowpipe within the spacer sleeve, providing a supply tube coupled to the pulse jet device, and coupling the supply tube to the transfer tube. In one example, the supply tube is flexible.

### FIELD OF THE INVENTION

The present invention relates generally to a system for cleaning filters in a baghouse, and more particularly, to a retrofit arrangement for pulse jet dust collectors for cleaning filters in a baghouse.

### BACKGROUND OF THE INVENTION

The invention relates generally to a system for cleaning filters in a baghouse. In particular, the invention relates to a retrofit arrangement coupling a pulse jet device providing a pressurized fluid to a blowpipe of the baghouse via an existing tubular fixture for cleaning filters in a baghouse with reverse pulses of the pressurized fluid.

Filters for removing particulates from a particulate-laden gas stream flowing through a baghouse are known. The particulates are typically generated by an industrial process and carried to the filters in the gas flow stream. The filters include media that is formed into filter cartridges or filter bags, etc. The particulate-laden gas flows through the filters from outside towards inside. The particulates are separated from the gas stream at the outer side of the filters. The filtered gas stream flows through the media and exits the filter through an open end. The filtered gas stream then is conducted to subsequent plant uses or the atmosphere.

Over time, a buildup of accumulated particulates form on the outer sides of the filters and becomes thicker and thicker. This increasing buildup of particulates causes an increase in pressure drop across the filters. This increased pressure drop is costly because more power is consumed to generate an effective-flow of gas through the filters.

The filters are periodically cleaned to remove the particulate buildup and reduce the pressure drop across the filters. To clean the filters, a pressurized fluid, such as air, is blown into the open end of the filters to dislodge the particulate buildup adhering to their outer sides. Known cleaning systems typically provide a pulse of compressed air into the filters at a supplied pressure in the range of about 70 to 100 PSI.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a method of replacing an existing threaded coupler on an existing tubular fixture having a first outer diameter and a first inner diameter and secured to a baghouse is provided to couple a pulse jet device providing a pressurized fluid to a blowpipe of the baghouse via the existing tubular fixture. The method includes the steps of disconnecting the blowpipe from the existing tubular fixture by removing the threaded coupler therefrom. The method further includes the steps of providing a spacer sleeve having a second inner diameter, and a second outer diameter in the range of about 95% to about 100% of the first inner diameter, and arranging the spacer sleeve within the existing tubular fixture such that a central axis of the spacer sleeve is generally co-axial with a central axis of the existing tubular fixture. The method further includes the steps of providing a transfer tube having a third inner diameter, and a third outer diameter in the range of about 95% to about 100% of the second inner diameter, and arranging the transfer tube within the spacer sleeve such that a central axis of the transfer tube is generally co-axial with the central axis of the spacer sleeve. The method further includes the steps of coupling the transfer tube to the spacer sleeve, coupling the spacer sleeve to the existing tubular fixture, arranging the blowpipe within the spacer sleeve, providing a supply tube coupled to the pulse jet device, and coupling the supply tube to the transfer tube.

In accordance with another aspect of the present invention, a method of replacing an existing threaded coupler on an existing tubular fixture having a first outer diameter, a first inner diameter, and a first length, and secured to a baghouse is provided to couple a supply tube providing a pressurized fluid to a blowpipe of the baghouse via the existing tubular fixture. The method includes the steps of disconnecting the blowpipe from the existing tubular fixture by removing the threaded coupler therefrom. The method further includes the steps of providing a spacer sleeve having a second inner diameter, a second outer diameter in the range of about 95% to about 100% of the first inner diameter, and a second length at least about 75% of the first length, and arranging the spacer sleeve within the existing tubular fixture such that a central axis of the spacer sleeve is generally co-axial with a central axis of the existing tubular fixture and at least a portion of the spacer sleeve is located within the baghouse. The method further includes the steps of providing a transfer tube having a third inner diameter, and a third outer diameter in the range of about 95% to about 100% of the second inner diameter, and arranging the transfer tube within the spacer sleeve such that a central axis of the transfer tube is generally co-axial with the central axis of the spacer sleeve and at least a portion of the transfer tube extends a distance away from the existing tubular fixture. The method further includes the steps of coupling the transfer tube to the spacer sleeve, coupling the spacer sleeve to the existing tubular fixture, arranging the blowpipe within the spacer sleeve, and coupling the supply tube to the transfer tube. The supply tube is a flexible tube adapted to be coupled to a pulse jet device for providing a pressurized fluid to the blowpipe.

In accordance with another aspect of the present invention, a retrofit coupling arrangement is provided for replacing an existing threaded coupler on an existing tubular fixture having a first outer diameter, a first inner diameter, and a first length, and secured to a baghouse to couple a pulse jet device providing a pressurized fluid to a blowpipe of the baghouse via the existing tubular fixture. The retrofit coupling arrangement includes a flexible supply tube adapted to be coupled to the pulse jet device, and a spacer sleeve having a second inner diameter, a second outer diameter in the range of about 95% to about 100% of the first inner diameter, and a second length at least about 75% of the first length. The spacer sleeve is arranged within the existing tubular fixture such that a central axis of the spacer sleeve is generally co-axial with a central axis of the existing tubular fixture and at least a portion of the spacer sleeve is located within the baghouse. The retrofit coupling arrangement further includes a transfer tube having a third inner diameter that is substantially equal to an inner diameter of the blowpipe, and a third outer diameter in the range of about 95% to about 100% of the second inner diameter. The transfer tube is arranged within the spacer sleeve such that a central axis of the transfer tube is generally co-axial with the central axis of the spacer sleeve, and at least a portion of the transfer tube extends a distance away from the existing tubular fixture and is adapted to be coupled to the flexible supply tube. The transfer tube is spaced a distance of less than about 25 millimeters from the blowpipe to maintain a substantially consistent cross-sectional flow area for the pressurized fluid within the existing tubular fixture, and the transfer tube is coupled to the spacer sleeve.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematic representation of an example baghouse and cleaning system;

FIG. 2 is an enlarged, sectional view of Detail area 2, 3, 4 of FIG. 1 illustrating a prior art coupling arrangement between a supply tube and a blowpipe;

FIG. 3 is an enlarged, sectional view of Detail area 2, 3, 4 of FIG. 1 illustrating a first example coupling arrangement between a supply tube and a blowpipe in accordance with one aspect of the present invention; and

FIG. 4 is similar to FIG. 3, but illustrates a second example coupling arrangement between a supply tube and a blowpipe n accordance with another aspect of the present invention.

### DESCRIPTION OF EXAMPLE EMBODIMENTS

Example embodiments that incorporate one or more aspects of the present invention are described an illustrated in the drawings. These illustrated examples are not intended to be a limitation on the present invention. For example, one or more aspects of the present invention can be utilized in other embodiments and even other types of devices.

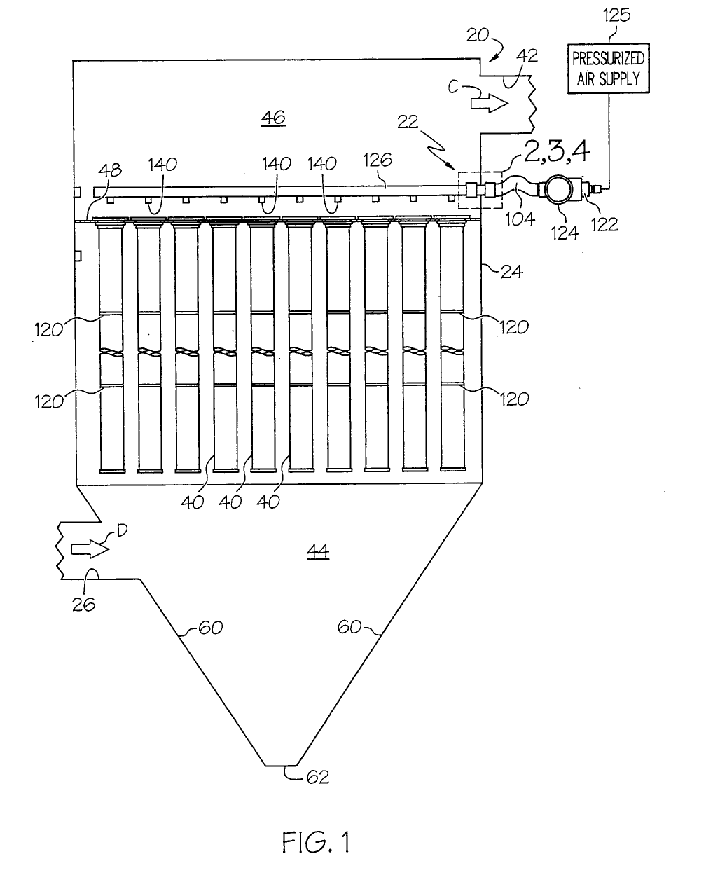

Turning to the shown example of FIG. 1, a baghouse 20 incorporating a reverse pulse filter cleaning system 22 is schematically illustrated. It is to be understood that the following provides a description of one example baghouse, and that the retrofit arrangement of the subject application can be utilized in various baghouses having various filter configurations. The baghouse 20 is defined by an enclosed housing 24. The housing 24 is made from a suitable material, such as sheet metal. Particulate-laden gas D flows into the baghouse 20 from an inlet 26 at a temperature generally between about ambient temperature and about 450° F., or even higher. The particulate-laden gas D is filtered by a plurality of filters 40 located within the baghouse 20. Filtered or clean gas C exits through an outlet 42 of the baghouse 20.

The baghouse 20 can be divided into a “dirty gas” plenum 44 and a “clean gas plenum 46 by a tubesheet 48 made from a suitable material, such as sheet metal. The inlet 26 is in fluid communication with the dirty gas plenum 44. The outlet 42 is in fluid communication with the clean gas plenum 46. The baghouse 20 can also have an accumulation chamber defined by sloped walls 60 located at a lower end of the dirty gas plenum 44. The accumulation chamber receives and temporarily stores particulates and other debris that are separated from the particulate-laden gas D or fall off of the filters 40. The stored particulates and debris exit the accumulation chamber through an opening 62. In one example, the tubesheet 48 can include a plurality of openings (not shown) extending therethrough, while a filter 40 is installed in a respective one of the openings. Each of the filters 40 is mounted within the respective opening so it seals against the tubesheet 48 and isolates the dirty gas plenum 44 from the clean gas plenum 46. While the filters 40 are illustrated as being mounted to extend in a substantially vertical direction, the filters could be mounted to extend in any direction, for example horizontally or at an angle. By way of example and not limitation, a circumferential resilient mounting band (not shown) can be located in each one of the openings in the tubesheet 48. The band provides the seal between the filter 40 and the opening in the tubesheet 48, and any suitable mounting structure may be used to attach, support and seal the filters 40 to the tubesheet 48.

The filters 40 filter particulates from the particulate-laden gas D as the gas passes through each filter. Each filter 40 can include conventional bags and cages, and/or may include pleated filter media. For example, the filter media can be formed into a tubular configuration with a circular cross section. It will be apparent that the filters 40 may be any desired length in order to meet the filtering requirements of the baghouse 20. The filter media may be constructed of any suitable material for desired filtering requirements and operating conditions. For example, materials such as polyester, acrylic and polypropylene are generally acceptable for operating temperatures in the range of 180° F. to 225° F. Aramid and PPS are suitable for up to 375° F. Fiberglass is suitable for use up to 450° F.

The filters 40 are illustrated as having retention devices 120 (FIG. 1) extending circumferentially about the pleated filter media. It is to be understood that conventional filters using bags and cages generally do not include such retention devices 120. However, where pleated filter cartridges are used, the retention devices 120 serve to hold the pleated filter media in place during reverse pulse cleaning of the filter cartridges 40. Specifically, the retention devices 120 limit movement of the pleated filter media in a radial outward direction during reverse pulse cleaning. The retention devices 120 may be in the form of a strap or an extruded elastomer.

The reverse pulse cleaning system 22 can include a plurality of pulse valves 122 (FIG. 1). Each pulse valve 122 is fluidly connected (directly or indirectly) to a pressurized fluid supply 125, such as a compressed air manifold or header 124 that supplies compressed fluid, such as air. Still, it is to be understood that various pressurized fluids can be used, including various liquids, gasses, and/or combinations thereof. Each of the pulse valves 122 is arranged to direct compressed air stored in the header 124 through a respective one of a plurality of blowpipes 126 (only one is illustrated). The blowpipes 126 are supported by the housing 24. Each of the blowpipes 126 has a plurality of nozzles 140. Periodically, the pulse valves 122 are operated to allow a pulse of compressed air to flow from the header 124, to the blowpipes 126, through the nozzles 140 and into the filters 40 while filtering operation of the baghouse 20 continues. The nozzle 140 defines a passage for the cleaning fluid (e.g., air, etc.) delivered from the blowpipe 126. The baghouse 20 does not have to be shut down during this cleaning operation so it does not go off-line. Still, some baghouses can be compartmentalized to isolate individual compartments that are cleaned off-line. The nozzles 140 can be positioned a predetermined distance from the tubesheet and located along the longitudinal central axis of a respective filter 40. It will also be apparent that nozzles could be eliminated entirely and openings could be formed in the blowpipe 126 for directing the cleaning pulses P into the filters 40.

The header 124 has an inner diameter D1 in the range of about 4 inches to 18 inches. Each of the blowpipes 126 has an inner diameter D2 in the range of about ¾ inch to 4 inches. The valves 122 are appropriately sized to the diameters of the header 124 and blowpipes 126.

After a period of filtering operation of the baghouse 20, a pressure drop across each of the filters 40 will increase due to the accumulation of particulates separated from the particulate-laden gas flow D and accumulate at the outer surfaces of the filters. The filters 40 are periodically cleaned by directing pulses P of a cleaning fluid, such as compressed air, into the open end of each of the filters (i.e., in a “reverse” or opposite direction to normal filtering gas flow). This cleaning is referred to as reverse pulse cleaning.

The reverse pulse cleaning system 22 can also includes a control system (e.g., such as a personal computer or PLC, not shown) for controlling the pulses P of the cleaning fluid. The control system can be open loop or closed loop, and can include various elements, such as a controller, the compressed air supply 125 and a regulator. The controller can have various sensors associated with it for determining the pressure differential or drop across the filters 40, such as a sensor located in the dirty gas plenum 44 and another sensor located in the clean gas plenum 46. The pressure differential or drop across the filters 40 is the pressure sensed by sensor in the dirty gas plenum 44 minus the pressure sensed by sensor in the clean gas plenum 46.

Referring to FIG. 1, the example reverse pulse cleaning system 22 including the aforedescribed elements is illustrated. The reverse cleaning pulse is provided by the cleaning system 22. Directing a cleaning pulse of compressed air is done periodically into each filter 40 through its open end. In general, the reverse pulse cleaning system 22 delivers a sufficient flow of fluid as the cleaning pulses P of compressed air to clean the filters 40. By “pulse”, it is meant a flow of a sufficient volume of gas at a pressure sufficient to overcome the filtering operation flow of particulate-laden gas D in the dirty gas plenum 44 for a limited time duration. The limited time duration may be in the range of about 0.1 second to 0.35 second. The pressure of the cleaning gas delivered by the air supply 125 and regulated by the regulator to the header 124 to generate the cleaning pulse is in the range of about 60 PSI to 100 PSI, and preferably in the range of about 60 PSI to 80 PSI. Still, various other pressures are also contemplated.

The volume flow from each of the nozzles 140 at this pressure is sufficient to overcome the operational filtering flow through the respective filters 40 and to dislodge or remove any accumulated particulates and debris from the outer surface of the filters. It is important to realize that the reverse cleaning pulse is delivered while the baghouse 20 is allowing filtering operation. The cleaning pulse locally overcomes the filter gas flow through the filters 40. Cleaning is done in rows of filters 40.

The cleaning pulse emerging from the nozzle 140 can create a pressure wave along the longitudinal extent of the filters 40. Due to the suddenly occurring pressure change and the reversal of the flow direction, the filters and accumulated particulate buildup are forced radially outward. The accumulated particulate buildup is separated from the outer surfaces of the filters. The separated accumulated particulate buildup drops into the accumulation chamber defined by the walls 60 and exits the baghouse 20 through the opening 62. The particulates can then be carried away from the baghouse 20, for instance, by means of a screw conveyor (not shown).

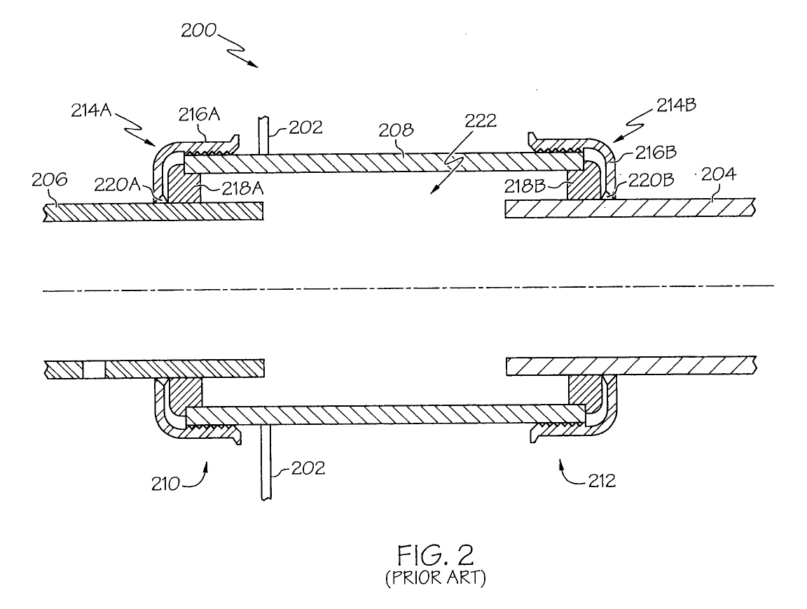

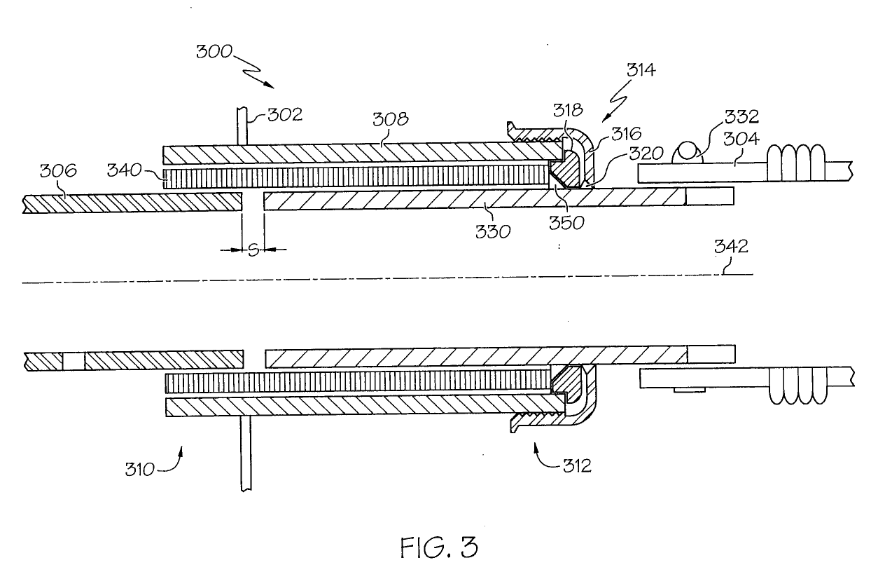

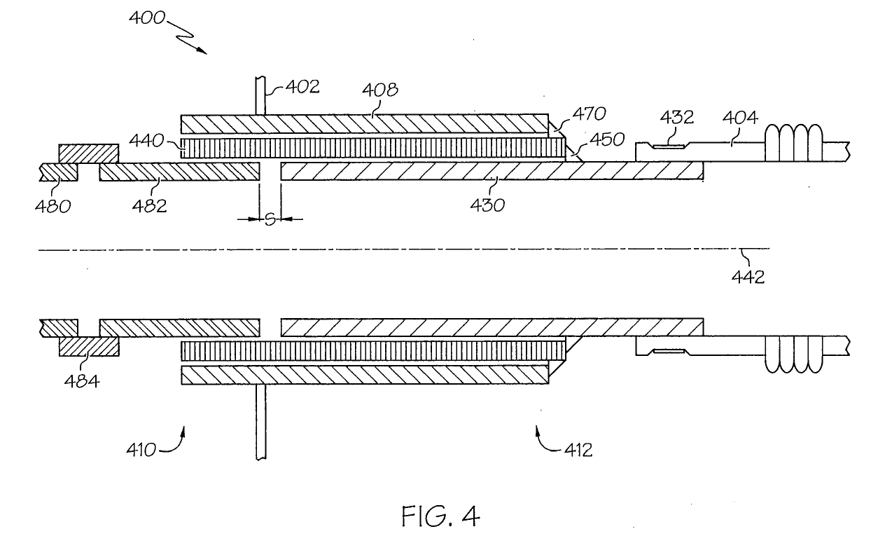

Attention is now directed to FIGS. 2-4, which each illustrate an enlarged view of Detail area 2, 3, 4 of FIG. 1. Each of FIGS. 2-4 showing a different arrangement that couples the pulse jet header 124 to the blowpipe 126. It is to be appreciated that FIG. 2 shows a prior art arrangement. FIGS. 3 and 4 show examples of embodiments in accordance with aspects of the present invention. For clarity, each of FIGS. 2-4 illustrates a sectional view taken through a portion of Detail area 2, 3, 4, such as a central portion thereof.

It is to be understood that where a baghouse 20 includes a plurality of blowpipes 126, each blowpipe 126 can be coupled to a separate header 124, or alternatively, multiple blow pipes 126 can be coupled together with the a single header 124.

Turning now to FIG. 2, a prior art arrangement 200 of coupling the pulse jet header 124 to the blowpipe 126 through a sidewall 202 of the baghouse 20 is illustrated. Generally, a rigid supply tube 204 is coupled to the pulse jet header 124 and extends towards the sidewall 202 in one direction, while an end 206 of the blowpipe 126 extends in a generally opposite direction towards the sidewall 202. It is to be understood that either of the supply tube 204 or the blowpipe end 206 can extend through the sidewall 202. A tubular fixture 208 extends through an opening in the sidewall 202. The tubular fixture 208 includes a first end 210 located within the baghouse 20, and a second end 212 located outside of the baghouse 20. The tubular fixture 208 is secured to the sidewall 202 in various manners, such as by fasteners, adhesives, welding, etc. The tubular fixture 208 can be a Schedule 40 pipe, such as a 2.5-inch, 3-inch, or 4-inch Schedule 40 pipe (i.e., about a 2.469-inch, 3.068-inch, or 4.026 internal diameter, respectively), though the tubular fixture 208 may also have various other, such as non-standard, dimensions. The tubular fixture 208 has a cross-sectional area generally larger than both of the supply tube 204 and the blowpipe end 206 such that each of the supply tube 204 and the blowpipe end 206 extend a distance into the tubular fixture 208.

Each of the supply tube 204 and the blowpipe end 206 are coupled to the tubular fixture 208 by a threaded coupler 214A, 214B. Each of the threaded couplers 214A, 214B can be similar or different, though for brevity only one coupler will be described with the understanding that such description similarly applies to both couplers 214A, 214B. The threaded coupler 214A is a compression arrangement including a compression nut 216A having internal threads that matingly engage corresponding external threads of the first end 210 of the tubular fixture 208. The compression nut 216A compresses a gasket 218A and a compression retainer ring 220A between the blowpipe end 206 and the first end 210 of the tubular fixture 208. Thus, the blowpipe end 206 is sealingly secured, in a removable fashion, to the first end 210 of the tubular fixture 208. A similar coupler 214B is provided to sealingly, and removably, secure the supply tube 204 top the second end 212 of the tubular fixture 208.

However, as previously described herein, the pulse jet cleaning system can provide periodic pulses of pressurized fluid in the range of about 60 PSI to 80 PSI, or even 100 PSI or more, to the baghouse 20 in an environment with a relatively high temperature that can reach about 450° F. or higher. Thus, each of the supply tube 204, the blowpipe end 206, the tubular fixture 208, and the threaded couplers 214A, 214B are continuously exposed to high pressure, high temperature impulse cycles, and may even be subject to high vibration levels. As a result, either or both of the threaded couplers 214A, 214B can work loose and/or even fall off of the ends 210, 212 of the tubular fixture 208. For example, if the threaded coupler 214A falls off of the first end 210, the blowpipe end 206 will become disconnected from the tubular fixture 208, and any pulsed air sent from the header 124 will not flow into the blowpipe 126, rendering the blowpipe 126 ineffective for cleaning the filters 40. Moreover, because the threaded coupler 214A is maintained within the interior of the baghouse 20, it is generally not visible to service personnel. As a result, a disconnected threaded coupler 214A and blowpipe end 206 may not be discovered for a relatively long time, and/or without increased difficulty, leading to decreased baghouse efficiency and/or damaged filters 40.

In addition or alternatively, because the tubular fixture 208 has a cross-sectional area generally larger than both of the supply tube 204 and the blowpipe end 206, the pressurized fluid must travel through the relatively smaller diameter of the supply tube 204, expand into the relatively larger diameter 222 area of the tubular fixture 208, and be compressed back into the relatively smaller diameter of the blowpipe end 206. As a result, increased energy must be expended due to the changes in pressure, volume, and/or velocity of the pressurized air within the relatively larger diameter 222 area of the tubular fixture 208, leading to decreased system efficiency.

Turning now to FIG. 3, one example retrofit arrangement 300 of coupling the pulse jet header 124 to the blowpipe 126 through a sidewall 302 of the baghouse 20 is illustrated in accordance with one aspect of the present application. The retrofit arrangement 300 can be a slip-fit arrangement. As before, a tubular fixture 308 extends through an opening in the sidewall 302. Indeed, the tubular fixture 308 can be the same, existing tubular fixture 208 as shown in FIG. 2, remaining from a previous installation, or alternatively, can be newly installed. The tubular fixture 308 includes a first end 310 located within the baghouse 20, and a second end 312 located outside of the baghouse 20. The tubular fixture 308 can be secured to the sidewall 302 in various manners, such as by fasteners, adhesives, welding, etc. The tubular fixture 308 includes a first inner diameter, a first outer diameter, and a first length (i.e., the length extending from the first end 310 to the second end 312). The tubular fixture 308 can have a generally cylindrical geometry, though it can also have various other geometries. In one example, the tubular fixture 308 can be a Schedule 40 pipe, such as a 2.5-inch, 3-inch, or 4-inch Schedule 40 pipe (i.e., about a 2.469-inch, 3.068-inch, or 4.026-inch internal diameter, and about a 2.375-inch, 3.5-inch, and 4.5-inch outer diameter, respectively), though it is to be understood that the tubular fixture 308 may have various other, such as non-standard, dimensions.

Also as before, a supply tube 304 is coupled to the pulse jet header 124 and extends towards the sidewall 302 in one direction, while an end 206 of the blowpipe 126 extends in a generally opposite direction towards the sidewall 302. It is to be understood that either or both of the supply tube 304 or the blowpipe end 306 can extend through the sidewall 302. Moreover, the tubular fixture 308 can generally have a cross-sectional area generally larger than both of the supply tube 304 and the blowpipe end 306 to permit each of the supply tube 304 and the blowpipe end 306 extend (i.e., telescope) a distance into the tubular fixture 308. Furthermore, it is to be understood that the supply tube 304 and the blowpipe end 306 can each have geometries corresponding to that of the tubular fixture 308 so as to be at least partially received therein.

Additionally, because the pulse jet headers 124 can be arranged relatively close to the sidewall 302 of the bag house 20, and because the baghouse 20 is often subject to relatively high temperatures that can deform the sidewalls 302 through which the existing tubular fixture 308 is connected, it can be difficult to maintain axial alignment between the pulse jet headers 124, the supply tube 304, and the existing tubular fixture 308. Thus, it can be beneficial to provide the supply tube 304 as a flexible tube that can compensate for axial misalignment of the pulse jet header 124 relative to the existing tubular fixture 308. For example, a flexible supply tube 104 is illustrated in FIG. 1. The flexible supply tube 304 can compensate for axial misalignment during the retrofit installation, and/or generally continuously during the operation of the baghouse 20. Similar to rigid supply tubes (i.e., see FIG. 2), the flexible supply tube 304 is adapted to be coupled to the pulse jet headers 124 for providing the pressurized fluid to the blowpipe 126. Various flexible supply tubes 304 can be utilized. In one example, the flexible supply tube 304 can include a flexible hose or the like formed of a generally flexible material, and/or may include flexible corrugations, etc. The flexible supply tube 304 can be flexible along its entire length, and/or can even have one or more generally rigid portions. Still, it is to be understood that a flexible supply tube is not required. For example, a rigid supply tube can be coupled to and utilized with the transfer tube 320, or alternatively, the transfer tube 320 can be coupled directly to the pulse jet header 124.

Thus, as shown in FIG. 3, the flexible supply tube 304 can be indirectly coupled to the tubular fixture 308 by way of a transfer tube 330. For example, at least a portion of the transfer tube 330 can extend a distance away from the existing tubular fixture 308 and be adapted to be coupled to the flexible supply tube 304. The transfer tube 330 can be at least partially received within the supply tube 304, and can be coupled thereto by fasteners, adhesives, welding, etc. In one example, the supply tube 304 can be coupled to the transfer tube 330 by a compression clamp 332 or the like extending about an outer perimeter thereof.

However, because the existing tubular fixture 308 can have a cross-sectional area generally larger than the supply tube 304, transfer tube 330 and/or the blowpipe end 306, the retrofit arrangement 300 can further be provided with a spacer sleeve 340. The spacer sleeve 340 can be arranged within the existing tubular fixture 308 such that a central axis 342 of the spacer sleeve 340 is generally co-axial with a central axis of the existing tubular fixture. The spacer sleeve 340 includes a second inner diameter, a second outer diameter, and a second length (i.e., the length extending from one end to the other). To provide a good fit within the existing tubular fixture 308, the second outer diameter can be in the range of about 90% to about 100% of the first inner diameter of the existing tubular fixture 308, or even about 95% to about 100% of the first inner diameter of the existing tubular fixture 308. As a result, a good fit can be established between the spacer sleeve 340 and the existing tubular fixture 308. Still, an additional spacer (not shown) can be provided therebetween. Moreover, it can be beneficial to provide the second length of the spacer sleeve 340 to be at least about 75% of the first length of the existing tubular fixture 308 such that the spacer sleeve 340 is supported along its length to inhibit, such as prevent, misalignment, binding, etc., and/or inadvertent disengagement thereof. Thus, as shown, at least a portion of the spacer sleeve 340 can be arranged within the existing tubular fixture 308 so as to be located within the baghouse 20 (i.e., interior of the baghouse sidewall 302).

The transfer tube 330 can have a third inner diameter, a third outer diameter, and a third length (i.e., the length extending from one end to the other). As discussed previously herein, where the tubular fixture 308 has a cross-sectional area generally larger than both of the supply tube 304 or transfer tube 330 and the blowpipe end 306, it can be undesirable for the pressurized fluid to expand into the relatively larger diameter area of the tubular fixture 308, and be compressed back into the relatively smaller diameter of the blowpipe end 306. Thus, it can be beneficial to have the internal cross-sectional area of the transfer tube 330 (i.e., the third inner diameter) to be generally similar, such as identical, to the internal cross-sectional area of the blowpipe end 306. In one example, where the blowpipe end 306 is generally a 1.5-inch pipe, such as a 1.5-inch Schedule 40 pipe (i.e., about a 1.610-inch internal diameter, and about a 1.9-inch outer diameter), it can be beneficial for the transfer tube 330 to similarly be a 1.5-inch Schedule 40 pipe (i.e., having the third inner diameter be about 1.610-inches). Moreover, it can also be beneficial to axially arrange the ends of the blowpipe end 306 and the transfer tube 330 to be spaced a relatively small distance S apart, such as a distance of less than about one inch (i.e., about 25 millimeters), or even less than about 0.4 inches (i.e., about 10 millimeters), so as to maintain a substantially consistent cross-sectional flow area for the pressurized fluid within the existing tubular fixture 308. In addition or alternatively, a spacer (not shown) can also be provided between the blowpipe end 306 and the transfer tube 330 to reduce the distance S. Generally, the blowpipe 126 and blowpipe end 306, are fixed within the baghouse 20, such as by a hitch pin or the like. Thus, the distance S may be adjusted via the transfer tube 330, although it may be possible to adjust the position of the blowpipe 126.

Similarly, to provide a good fit within the spacer sleeve 340, the transfer tube 330 can have a third outer diameter in the range of about 90% to about 100% of the second inner diameter of the spacer sleeve 340, or even about 95% to about 100% of the second inner diameter of the spacer sleeve 340. In one example, wherein the transfer tube 330 is a 1.5-inch Schedule 40 pipe (i.e., about a 1.610-inch internal diameter, and about a 1.9-inch outer diameter) so as to be similar to the blowpipe end, it can be beneficial for the spacer sleeve 340 to be a 2-inch Schedule 80 pipe (i.e., about a 1.939-inch internal diameter, and about a 2.375 inch outer diameter). Thus, in this configuration, the third outer diameter of the transfer tube 330 (i.e., about 1.9-inches) is approximately 98% of the second inner diameter (i.e., 1.939-inches) of the spacer sleeve 340. As a result, a good fit can be established between the transfer tube 330 and the spacer sleeve 340. During assembly, the transfer tube 330 can be arranged within the spacer sleeve 340 such that a central axis (not shown) of the transfer tube 330 is generally co-axial with a central axis 342 of the spacer sleeve 340.

The transfer tube 330 and spacer sleeve 340 can each be coupled to the tubular fixture 308, directly or indirectly, in various manners. In one example, the transfer tube 330 can be coupled to the tubular fixture 308 by a threaded coupler 314 which can be similar to, or even the same as, the existing threaded coupler 214B as shown in FIG. 2, remaining from a previous installation, or alternatively, can be newly installed. Thus, in one example, the threaded coupler 314 can be a compression arrangement including a compression nut 316 having internal threads that matingly engage corresponding external threads of the first end 310 of the tubular fixture 308. The compression nut 316 can compress a seal gasket 318 and a compression retainer ring 320 between the transfer tube 330 and the first end 310 of the tubular fixture 308. Thus, the transfer tube 330 can be sealingly secured, in a removable fashion, to the first end 310 of the tubular fixture 308.

In another example, the transfer tube 330 can be removably or non-removably coupled to the spacer sleeve 340 fasteners, adhesives, welding, etc. As shown, the transfer tube 330 can be welded to the spacer sleeve 340 by one or more weld(s) 350. The weld(s) 350 can be generally continuous about an outer perimeter of the transfer tube 330, so as to provide a substantially sealed joint, or may include a plurality of welds extending about portions of the transfer tube 330. In addition or alternatively, an additional seal element or the like (not shown) can be provided between the transfer tube 330 and the spacer sleeve 340. In the case of a retrofit, the transfer tube 330 can be welded to the spacer sleeve 340 in a factory, or may even be welded on-site. In either case, the transfer tube 330 can be welded to the spacer sleeve 340 before, or even after, the spacer sleeve 340 is arranged within the existing tubular fixture 308. Thus, the transfer tube 330 can be sealingly secured, in a generally non-removable fashion, to the spacer sleeve 340. As a result, in the instant retrofit arrangement 300, the transfer tube 330 is directly coupled and sealed to the existing tubular fixture 308, while the spacer sleeve 340 is indirectly coupled and sealed to the existing tubular fixture 308.

Turning now to the example shown in FIG. 4, another example retrofit arrangement 400 of coupling the pulse jet header 124 to the blowpipe 126 through a sidewall 402 of the baghouse 20 using a slip-fit arrangement is illustrated in accordance with another aspect of the present application. It is to be understood that reference numbers of the 400-series (i.e., 400, 402, 404, etc.) are used to correspond to reference numbers of the 300-series of FIG. 3, and are intended to indicate similar, such as identical, elements (i.e., 400 is similar to 300, 402 is similar to 302, etc.), incorporating all description thereof. Substantially different or new elements are illustrated with different reference numbers.

As shown, the transfer tube 430 is arranged generally within the spacer sleeve 440, and is sealingly secured thereto by one or more welds 450. However, the threaded coupler (i.e., 314, see FIG. 3) is not used. Instead, the spacer sleeve 440 can be welded to the existing tubular fixture 408 by one or more weld(s) 470. The weld(s) 470 can be generally continuous about an outer perimeter of the spacer sleeve 440, so as to provide a substantially sealed joint, or may include a plurality of welds extending about portions of the spacer sleeve 440. In addition or alternatively, an additional seal element or the like (not shown) can be provided between the existing tubular fixture 408 and the spacer sleeve 440. In the case of a retrofit, the spacer sleeve 440 can be welded on-site to the existing tubular fixture 408. As a result, in the instant retrofit arrangement 400, the transfer tube 430 is indirectly coupled and sealed to the existing tubular fixture 408, while the spacer sleeve 440 is directly coupled and sealed to the existing tubular fixture 408.

In addition or alternatively, as shown in FIG. 4, the blowpipe 480 can be indirectly coupled to the spacer sleeve 440 by a blowpipe adapter 482. In one example, as discussed herein, the blowpipe 126 may be a 2.5-inch Schedule 40 pipe that would not fit within the spacer sleeve 440. In other examples, the blowpipe 480 may have non-standard dimensions, and/or may be physically arranged at a distance from the existing tubular fixture 408. Still, it is to be understood that the foregoing discussion of the blowpipe end 306 relative to the spacer sleeve 340 (i.e., see FIG. 3) applies similarly to the blowpipe adapter 482 and spacer sleeve 440. Similarly, the blowpipe adapter 482 can be utilized with the arrangement 300 of FIG. 3. The blowpipe adapter 482 can have a first end that is removably or non-removably coupled to an end of the blowpipe 480 by a suitable coupler element 484, and/or fasteners, welding, adhesives, etc. A flexible intermediate element (not shown) may even be provided between the blowpipe 480 and the blowpipe adapter 482. The blowpipe adapter 482 can also have a second end arranged within the spacer sleeve 440 so as to be generally co-axial therewith. The second end of the blowpipe adapter 482 can also be arranged less than about one inch (i.e., 25 millimeters) from the end of the transfer tube 430. Similar to the transfer tube 430, the second end of the blowpipe adapter 482 can have a fourth outer diameter in the range of about 90% to about 100% of the second inner diameter of the spacer sleeve 440, or even about 95% to about 100% of the second inner diameter of the spacer sleeve 440 so as to provide a good fit therewith. For example, the blowpipe adapter can be a 1.5-inch Schedule 40 pipe.

An example method of replacing the existing threaded coupler on the existing tubular fixture will now be described, incorporating associated elements discussed herein. In short, at least one threaded coupler can be replaced with a slip-fit arrangement, such as the retrofit arrangements 300, 400 discussed herein. It is to be understood that the following steps can be performed in various orders, and that more or less steps may be included.

Turning briefly to FIG. 2, the blowpipe end 206 is disconnected from the existing tubular fixture 208 by removing the threaded coupler 214A, and associated elements (i.e., 216A, 218A, 220A) therefrom. Similarly, the rigid supply tube 204 can be disconnected from the tubular fixture 208 by removing the threaded coupler 214B, and associated elements (i.e., 216B, 218B, 220B) therefrom. Turning now to FIG. 3, the transfer tube 330 can be arranged within the spacer sleeve 340 so as to be generally co-axial therewith, and may be directly or indirectly coupled thereto. In one example, the transfer tube 330 can be welded (i.e., weld 350) to the spacer sleeve 340. The spacer sleeve 340 can be arranged within the existing tubular fixture 308 so as to be generally co-axial therewith, and may be directly or indirectly coupled thereto. In one example, the spacer sleeve 340 can be welded (i.e., weld 470) to the existing tubular fixture 308. In another example, the transfer tube 330 can be coupled to the existing tubular fixture 308 by a threaded coupler 314 such that the spacer sleeve 340 is indirectly coupled to the tubular fixture 308. Thus, each of the tubular fixture 308, transfer tube 330, spacer sleeve 340 can be arranged generally co-axially. The blowpipe end 306 can be arranged within one end of the spacer sleeve 340 generally opposite the transfer tube 330, and spaced a relatively small distance therefrom, such as less than about one inch (i.e., about 25 millimeters). Finally, the flexible supply tube 304 is coupled at one end to the pulse jet header 124, and at the other end to the transfer tube 330, such as by a compression clamp 332 or the like. Thus, the pulse jet header 124 is arranged in fluid communication with the blowpipe 126 via the existing tubular coupler 308. Moreover, the slip-fit arrangements 300, 400 discussed herein can provide increased resistance to inadvertent disengagement of the pulse jet header 124 from the blowpipe 126.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A method of replacing an existing threaded coupler on an existing tubular fixture having a first outer diameter and a first inner diameter and secured to a baghouse to couple a pulse jet device providing a pressurized fluid to a blowpipe of the baghouse via the existing tubular fixture, the method including the steps of:
disconnecting the blowpipe from the existing tubular fixture by removing the threaded coupler therefrom;
providing a spacer sleeve having a second inner diameter, and a second outer diameter in the range of about 95% to about 100% of the first inner diameter;
arranging the spacer sleeve within the existing tubular fixture such that a central axis of the spacer sleeve is generally co-axial with a central axis of the existing tubular fixture;
providing a transfer tube having a third inner diameter, and a third outer diameter in the range of about 95% to about 100% of the second inner diameter;
arranging the transfer tube within the spacer sleeve such that a central axis of the transfer tube is generally co-axial with the central axis of the spacer sleeve;
coupling the transfer tube to the spacer sleeve;
coupling the spacer sleeve to the existing tubular fixture;
arranging the blowpipe within the spacer sleeve;
providing a supply tube coupled to the pulse jet device; and
coupling the supply tube to the transfer tube.

2. The method of claim 1, wherein the transfer tube is coupled to the spacer sleeve by welding.

3. The method of claim 1, wherein the spacer sleeve is coupled to the existing tubular fixture by welding.

4. The method of claim 1, wherein the existing tubular fixture includes external threads, and wherein the transfer tube is coupled to the existing tubular fixture by a threaded compression fitting that mates with said external threads.

5. The method of claim 1, further including the step of providing a seal between the transfer tube and the existing tubular fixture.

6. The method of claim 1, wherein the supply tube is a flexible tube adapted to be coupled to a pulse jet device for providing the pressurized fluid to the blowpipe.

7. The method of claim 1, further including the step of providing a blowpipe adapter having a first end coupled to the blowpipe, and a second end arranged within the spacer sleeve, wherein the second end has a fourth outer diameter in the range of about 95% to about 100% of the second inner diameter.

8. The method of claim 1, wherein the third inner diameter of the transfer tube is substantially equal to an inner diameter of the blowpipe, the method further including the step of arranging the axial positions of the transfer tube and the blowpipe within the spacer sleeve to be spaced a distance apart of less than about 10 millimeters to maintain a substantially consistent cross-sectional flow area for the pressurized fluid within the existing tubular fixture.

9. The method of claim 1, wherein the spacer sleeve is a two-inch schedule 80 pipe, and the transfer tube is a one and one-half inch schedule 40 pipe.

10. A method of replacing an existing threaded coupler on an existing tubular fixture having a first outer diameter, a first inner diameter, and a first length, and secured to a baghouse to couple a supply tube providing a pressurized fluid to a blowpipe of the baghouse via the existing tubular fixture, the method including the steps of:
disconnecting the blowpipe from the existing tubular fixture by removing the threaded coupler therefrom;
providing a spacer sleeve having a second inner diameter, a second outer diameter in the range of about 95% to about 100% of the first inner diameter, and a second length at least about 75% of the first length;
arranging the spacer sleeve within the existing tubular fixture such that a central axis of the spacer sleeve is generally co-axial with a central axis of the existing tubular fixture and at least a portion of the spacer sleeve is located within the baghouse;
providing a transfer tube having a third inner diameter, and a third outer diameter in the range of about 95% to about 100% of the second inner diameter;
arranging the transfer tube within the spacer sleeve such that a central axis of the transfer tube is generally co-axial with the central axis of the spacer sleeve and at least a portion of the transfer tube extends a distance away from the existing tubular fixture;
coupling the transfer tube to the spacer sleeve;
coupling the spacer sleeve to the existing tubular fixture;
arranging the blowpipe within the spacer sleeve; and
coupling the supply tube to the transfer tube, wherein the supply tube is a flexible tube adapted to be coupled to a pulse jet device for providing a pressurized fluid to the blowpipe.

11. The method of claim 10, wherein the transfer tube is coupled to the spacer sleeve by welding prior to the spacer sleeve being arranged within the existing tubular fixture.

12. The method of claim 10, wherein the spacer sleeve is coupled to the existing tubular fixture by welding.

13. The method of claim 10, wherein the existing tubular fixture includes external threads, and wherein the transfer tube is coupled to the existing tubular fixture by a threaded compression fitting that mates with said external threads.

14. The method of claim 10, further including the step of providing a blowpipe adapter having a first end coupled to the blowpipe, and a second end arranged within the spacer sleeve, wherein the second end has a fourth outer diameter in the range of about 95% to about 100% of the second inner diameter.

15. The method of claim 10, wherein the third inner diameter of the transfer tube is substantially equal to an inner diameter of the blowpipe, the method further including the step of arranging the axial positions of the transfer tube and the blowpipe within the spacer sleeve to be spaced a distance apart of less than about 10 millimeters to maintain a substantially consistent cross-sectional flow area for the pressurized fluid within the existing tubular fixture.

16. The method of claim 10, wherein the spacer sleeve is a two-inch schedule 80 pipe, and the transfer tube is a one and one-half inch schedule 40 pipe.

17. A retrofit coupling arrangement for replacing an existing threaded coupler on an existing tubular fixture having a first outer diameter, a first inner diameter, and a first length, and secured to a baghouse to couple a pulse jet device providing a pressurized fluid to a blowpipe of the baghouse via the existing tubular fixture, the retrofit coupling arrangement including:
a flexible supply tube adapted to be coupled to the pulse jet device;
a spacer sleeve having a second inner diameter, a second outer diameter in the range of about 95% to about 100% of the first inner diameter, and a second length at least about 75% of the first length, the spacer sleeve being arranged within the existing tubular fixture such that a central axis of the spacer sleeve is generally co-axial with a central axis of the existing tubular fixture and at least a portion of the spacer sleeve is located within the baghouse;
a transfer tube having a third inner diameter that is substantially equal to an inner diameter of the blowpipe, and a third outer diameter in the range of about 95% to about 100% of the second inner diameter, the transfer tube being arranged within the spacer sleeve such that a central axis of the transfer tube is generally co-axial with the central axis of the spacer sleeve, at least a portion of the transfer tube extends a distance away from the existing tubular fixture and is adapted to be coupled to the flexible supply tube, and the transfer tube is spaced a distance of less than about 25 millimeters from the blowpipe to maintain a substantially consistent cross-sectional flow area for the pressurized fluid within the existing tubular fixture, the transfer tube being coupled to the spacer sleeve.

18. The coupling arrangement of claim 17, wherein the transfer tube is welded to the spacer sleeve.

19. The coupling arrangement of claim 17, wherein the spacer sleeve is a two-inch schedule 80 pipe, and the transfer tube is a one and one-half inch schedule 40 pipe.

20. The coupling arrangement of claim 17, wherein the existing tubular fixture includes external threads, and wherein the transfer tube is coupled to the existing tubular fixture by a threaded compression fitting that mates with said external threads.
